(19) United States
(12) Patent Application Publication
(10) Pub. No.: US 2018/0041842 A1
(43) Pub. Date: Feb. 8, 2018

(54) MEMS MICROPHONE ELEMENT AND MANUFACTURING METHOD THEREOF

(71) Applicant: GOERTEK.INC, Weifang City, Shandong (CN)

(72) Inventor: Guoguang ZHENG, Weifang City, Shandong (CN)

(73) Assignee: GOERTEK. INC, Weifang City, Shandong (CN)

(21) Appl. No.: 15/554,942

(22) PCT Filed: Dec. 10, 2015
(86) PCT No.: PCT/CN2015/096915

§ 371 Date: Aug. 31, 2017

(30) Foreign Application Priority Data
May 29, 2015 (CN) 201510288675.5

(51) Int. Cl. H04R 19/04; H04R 31/00; H04R 7/16; H04R 7/04; H04R 19/00

(52) U.S. Cl. CPC H04R 19/04; H04R 7/04; H04R 19/005; H04R 7/16; H04R 31/003; H04R 2201/003; H04R 2410/01

(57) ABSTRACT

The present invention discloses a MEMS microphone element, comprising a base, the base being provided with a first opening and a second opening which run through from top to bottom; and a first capacitor and a second capacitor disposed on the base in parallel, the first capacitor being disposed on the first opening, and the second capacitor being disposed on the second opening, wherein the first capacitor comprises a first back pole plate located below, and a first vibrating diaphragm located above and opposite to the first back pole plate, the second capacitor comprises a second back pole plate located above, and a second vibrating diaphragm located on below and opposite to the second back pole plate; and the first capacitor and the second capacitor form a pair of differential capacitors together.

### CROSS REFERENCE TO RELATED APPLICATION

This application is a national stage application, filed under 35 U.S.C. §371, of International Application No. PCT/CN2015/096915, filed on Dec. 10, 2015, which claims priorities to Chinese Application No. 201510288675.5 filed on May 29, 2015, the content of which is hereby incorporated reference in its entirety.

### FIELD OF THE INVENTION

The present invention relates to microphones, in particular to a differential-capacitance type micro electro-mechanical systems (MEMS) microphone element and a manufacturing method thereof.

### BACKGROUND OF THE INVENTION

A MEMS microphone is a electroacoustic transducer manufactured by using a micromechanical machining technology, and it has advantages of small size, good frequency response characteristics, low noise, etc. With the trends of developing miniaturized and thinner electronic devices, the MEMS microphone is more and more widely applied to these devices.

A current MEMS microphone product contains a MEMS chip substrate on capacitance detection and an ASIC chip, a capacitance of the MEMS chip will generate corresponding changes along with the difference of input sound signals, and then the ASIC chip is used to process and output a changed capacitance signal, such that sound is pickup. The MEMS chip generally includes a base having a back cavity and a parallel plate capacitor disposed on the base and consisting of back pole plates and vibrating diaphragm. The vibrating diaphragm receives external sound signals and vibrates, such that the parallel plate capacitor generates a changed electrical signal, thereby realizing an acoustic-electrical conversion function.

Problems of the technical solution above are that single capacitance detection cannot filter external interference signals, a noise level of output signals is affected, and a signal-noise ratio is reduced.

If the MEMS microphone is designed into traditional differential-capacitance detection, and a three-layer film structure is adopted, wherein a upper layer and a lower layer serve as back pole plates, a middle layer serves as a vibrating diaphragm, and the vibrating diaphragm forms a capacitor together with the upper and lower layers of back pole plates respectively, and these two capacitors form the differential capacitor. When sound waves act on the vibrating diaphragm in the middle position, the vibrating diaphragm vibrates up and down, resulting in an increase of one capacitance of the differential capacitors while resulting in a decrease of the other, realizing differential detection on the sound waves is realized. But this solution has problems that the process is relatively complex, and intervals between the upper and lower back pole plates and the vibration are difficult to control. As a result, it is very difficult to make static capacitance and sensitivity of the differential capacitor same, resulting in weakening a differential effect and in deviating from the original purpose.

Therefore, there is a demand in the art that a new solution for a differential-capacitance type micro electro-mechanical systems (MEMS) microphone element and a manufacturing method thereof shall be proposed to address at least one of the problems in the prior art.

### SUMMARY OF THE INVENTION

One object of this invention is to provide a differential-capacitance type MEMS microphone element with better performance.

According to a first aspect of the present invention, there is provided a MEMS microphone element, comprising a base, the base being provided with a first opening and a second opening which run through from top to bottom; and a first capacitor and a second capacitor disposed on the base in parallel, the first capacitor being disposed on the first opening, and the second capacitor being disposed on the second opening, wherein the first capacitor comprises a first back pole plate located below, and a first vibrating diaphragm located above and opposite to the first back pole plate, the second capacitor comprises a second back pole plate located above, and a second vibrating diaphragm located below and opposite to the second back pole plate; and the first capacitor and the second capacitor form differential capacitors together.

Alternatively or optionally, the first vibrating diaphragm and the second back pole plate are made of the same material, and the first back pole plate and the second vibrating diaphragm are made of the same material.

Alternatively or optionally, the first vibrating diaphragm and the second vibrating diaphragm are electrically connected together to serve as a shared movable pole plate of the differential capacitors.

Alternatively or optionally, sensing parts of the first back pole plate and the second back pole plate are respectively provided with a plurality of through holes, and the first vibrating diaphragm and the second vibrating diaphragm are provided with a through hole at their central positions respectively.

Alternatively or optionally, the first back pole plate, the first vibrating diaphragm, the second back pole plate and the second vibrating diaphragm are made of any one of the following materials: polycrystalline silicon, silicon nitride attached with a polycrystalline silicon layer, and silicon nitride attached with a metal layer.

Alternatively or optionally, the MEMS microphone element is suitable for two kinds of product structures in which a sound signal enters into the MEMS microphone element from above or below.

According to a second aspect of the present invention, there is provided with a method for manufacturing a MEMS microphone element, which comprises the following steps: S1, providing a substrate; S2, growing a first isolating layer on the substrate; S3, growing a first pole plate material layer on the first isolating layer; patterning and etching the first pole plate material layer to form a back pole plate of a first capacitor, a movable pole plate of a second capacitor and a first isolating groove for isolating the back pole plate of the first capacitor from the movable pole plate of the second capacitor; S4, depositing a second isolating layer on the first pole plate material layer; forming a connecting window on the second isolating layer above the movable pole plate of the second capacitor, for connecting a movable pole plate of the first capacitor with the movable pole plate of the second capacitor; S5, growing a second pole plate material layer on the second isolating layer; patterning and etching the second pole plate material layer to form the movable pole plate of the first capacitor, a back pole plate of the second capacitor and an isolating groove for isolating the movable pole plate of the first capacitor from the back pole plate of the second capacitor; S6, etching the substrate and the first isolating layer to form a first opening below the first capacitor and to form a second opening below the second capacitor, in which the first opening and the second opening run through from top to bottom; and etching the second isolating layer to form a clearance between the back pole plate and movable pole plate of the first and the second capacitor, respectively.

Alternatively or optionally, in the step S3, a plurality of through holes are formed in the back pole plate of the first capacitor and a through hole is formed in the central position of the movable pole plate of the second capacitor; and in the step S5, a plurality of through holes are formed in the back pole plate of the second capacitor and a through hole is formed in the central position of the movable pole plate of the first capacitor.

Alternatively or optionally; a thickness of the back pole plate of the first capacitor is larger than that of the movable pole plate, and a thickness of the back pole plate of the second capacitor is larger than that of the movable pole plate.

Alternatively or optionally, the MEMS microphone element is suitable for two kinds of product structures in which a sound signal enters into the MEMS microphone element from above or below.

According to the differential-capacitance type MEMS microphone of the present invention, a pair of differential capacitors is designed side by side, differential detection is realized by two layers of films, and the present invention has the following beneficial effects,

1. The differential-capacitance type MEMS microphone is realized, and is favorable for filtering outside electromagnetic and noise interferences, improving a signal-noise ratio and a reception quality of output signals.

2. Since the clearances between the back pole plates and the movable pole plates of the differential capacitors are finished in one step, intervals of the differential capacitors can be made totally consistent, improving a differential effect.

3. The process flow of manufacturing is simple in flow and easy to control. The process flow is totally compatible with the current process for a single-capacitance type MEMS microphone, and the process needs no change.

The inventors of the present invention have found that there is still no single-chip differential capacitor-type MEMS microphone of a dual-layer film structure in the prior art, therefore, the present invention is a new technical solution. Further features of the present invention and advantages thereof will become apparent from the following detailed description of exemplary embodiments according to the present invention with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIGS. 1-2 are schematic diagrams of an embodiment of a MEMS microphone of the present invention.

FIGS. 3-4 are schematic diagrams of a differential detection principle of the MEMS microphone of the present invention.

FIGS. 5-14 are schematic diagrams of respective stages of a manufacturing process for the MEMS microphone of the present invention.

### DETAILED DESCRIPTION OF THE EMBODIMENTS

Various exemplary embodiments of the present invention will now be described in detail with reference to the drawings. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

Specific to the problems mentioned above, the present patent provides a novel differential-capacitance type MEMS microphone. A pair of differential capacitors is designed side by side and is realized by two layers of films, reducing the difficulty of process.

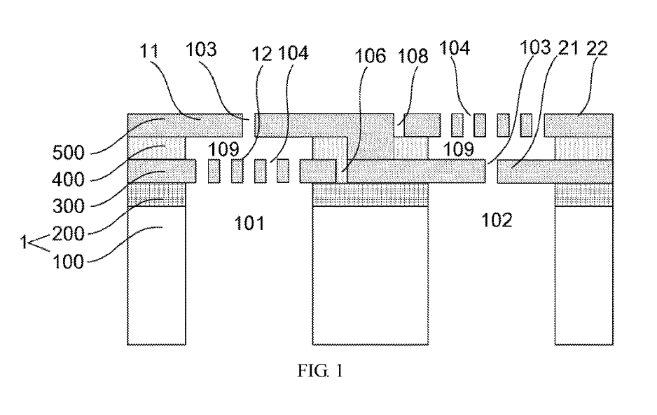

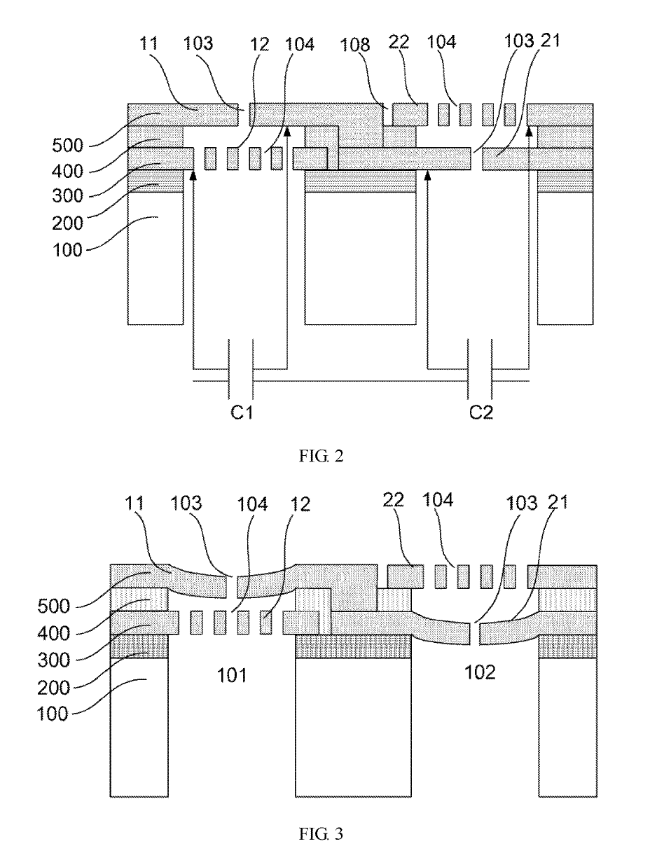

FIGS. 1-2 show a basic structure of the present invention, the structure comprising a base 1, a first capacitor C1 and a second capacitor C2 disposed on the base 1 in parallel, wherein the base 1 comprises a substrate 100 and a first isolating layer 200 located on the substrate 100. The base 1 is provided with a first opening 101 and a second opening 102 which run through from top to bottom; and the first capacitor C1 is disposed on the first opening 101, and the second capacitor C2 is disposed on the second opening 102. The first capacitor C1 comprises a first back pole plate 12 located below, and a first vibrating diaphragm 11 above and opposite to the first back pole plate 12; and the second capacitor C2 comprises a second back pole plate 22 located above, and a second vibrating diaphragm 21 located below and opposite to the second back pole plate 22. A second isolating layer 400 is respectively disposed between the first back pole plate 12 and the first vibrating diaphragm 11, and between the second pole plate 22 and the second vibrating diaphragm 21, to form a clearance 109 respectively between the first back pole plate 12 and the first vibrating diaphragm 11, and between the second pole plate 22 and the second vibrating diaphragm 21.

The first back pole plate 12 and the second back pole plate 22 are fixed pole plates, and the first vibrating diaphragm 11 and the second vibrating diaphragm 21 are movable pole plates.

The first capacitor C1 and the second capacitor C2 form a pair of differential capacitors, the first vibrating diaphragm 11 and the second vibrating diaphragm 21 are electrically connected together to serve as a shared movable pole plate of the differential capacitors, the first back pole plate 12. and the second vibrating diaphragm 21 are isolated by an insulating layer 106, and the first vibrating diaphragm 11 and the second back pole plate 22 are isolated by an isolating groove 108.

Sensing parts of the first back pole plate 12 and the second back pole plate 22 are respectively provided with a plurality of through holes 104, the first vibrating diaphragm 11 and the second vibrating diaphragm 21 are provided with a through hole 103 at their central positions respectively, and the through holes 103 and 104 play roles of sound conduction and sound pressure balancing.

The first vibrating diaphragm 11 and the second back pole plate 22 are made of the same material, and the first back pole plate 12 and the second vibrating diaphragm 21 are made of the same material. A thickness of the back pole plate 12 of the first capacitor C1 can be equal to or larger than that of the movable pole plate 11, and a thickness of the back pole plate 22 of the second capacitor C2. can be equal to or larger than that of the movable pole plate 21.

The first back pole plate 12, the first vibrating diaphragm 11, the second back pole plate 22 and the second vibrating diaphragm 21 are made of any one of the following materials: polycrystalline silicon, silicon nitride attached with a polycrystalline silicon layer and silicon nitride attached with a metal layer. A material of the first isolating layer 200 for example is silicon oxide. The second isolating layer 400 for example can be an oxide layer, and the insulating layer 106 can be a part of the second isolating layer 400.

From FIG. 1, it can be seen that the MEMS microphone element is suitable for a TOP product structure in which a sound signal enters into the MEMS microphone element from above, and is also suitable for a BOTTOM product structure in which a sound signal enters into from below.

From FIGS. 1-2, it can be seen that according to the present invention, two MEMS structures are disposed in one single chip, In the first capacitor C1, the vibrating diaphragm 11 is above and the back pole plate 12 is below; and in the second capacitor C2, the vibrating diaphragm 21 is below and the back pole plate 22 is above. The back pole plate 12 of the first capacitor C1 and the vibrating diaphragm 21 of the second capacitor C2 are manufactured simultaneously, and are made of the same material, for example, the polycrystalline silicon, or material of silicon nitride attached with a metal layer; and the vibrating diaphragm 11 of the first capacitor C1 and the back pole plate 22 of the second capacitor 22 are manufactured simultaneously, and are made of the same material, for example, the polycrystalline silicon, The back pole plate 12 of the first capacitor C1 and the vibrating diaphragm 21 of the second capacitor C2 are made of a first pole plate material layer 300, and the vibrating diaphragm 11 of the first capacitor Cl and the back pole plate 22 of the second capacitor C2 are made of a second pole plate material layer 500.

According to the special process design in the present invention, the vibrating diaphragm of the first capacitor C1 and the vibrating diaphragm of the second capacitor C2 are electrically connected together as a shared movable pole plate of the differential capacitors. When sound waves act on, the capacitance of the first capacitor C1 is increased, then the capacitance of the second capacitor C2 is reduced, or the capacitance of the first capacitor C1 is reduced, then the capacitance of the second capacitor C2 is increased, Specifically speaking, when there are no sound wave actions, C1=C2=C0. When sound waves enter into the microphone from a sound hole, the followings will happen.

If a sound pressure has a downward action, as shown in FIG. 3, the first vibrating diaphragm 11 moves downwards, resulting in a decrease of an interval between the first vibrating diaphragm 11 and the first back pole plate, and in a increase of the first capacitance C1; and the second vibrating diaphragm 21 also moves downwards, resulting in a increase of an interval between the second vibrating diaphragm 21 and the second back pole plate 22, and in a decrease of the second capacitance C2. Therefore, the first capacitance C1 is larger than C0, and C0 is larger than the second capacitance C2, that is, C1>C0>C2.

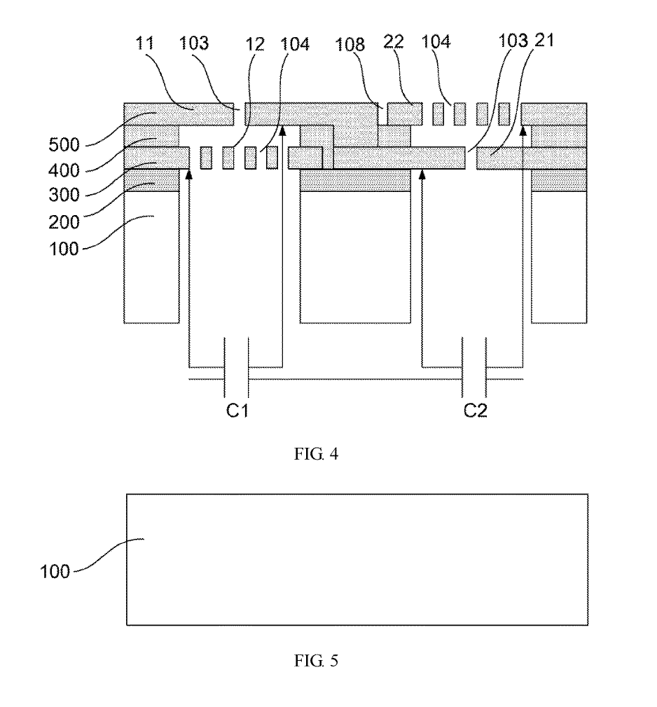

If the sound pressure has an upward action, as shown in FIG. 4, the first vibrating diaphragm 11 moves upwards, resulting in a increase of an interval between the first vibrating diaphragm 11 and the first back pole plate 12, and in a decrease of the first capacitance C1; and the second vibrating diaphragm 21 also moves upwards, resulting in a decrease of an interval between the second vibrating diaphragm 21 and the second back pole plate 22, and in a increase of the second capacitance C2. Therefore, the first capacitance C1 is smaller than C0, and C0 is smaller than the second capacitance C2 that is, C1<C0>C2.

According to differential design of the present invention, it is favorable for filtering outside electromagnetic and noise interferences, improving a signal-noise ratio and a reception quality of output signals.

A manufacturing method for a MEMS microphone of the present invention is introduced with reference to FIGS. 5-14.

1) Referring to FIG. 5, a substrate 100 is provided.

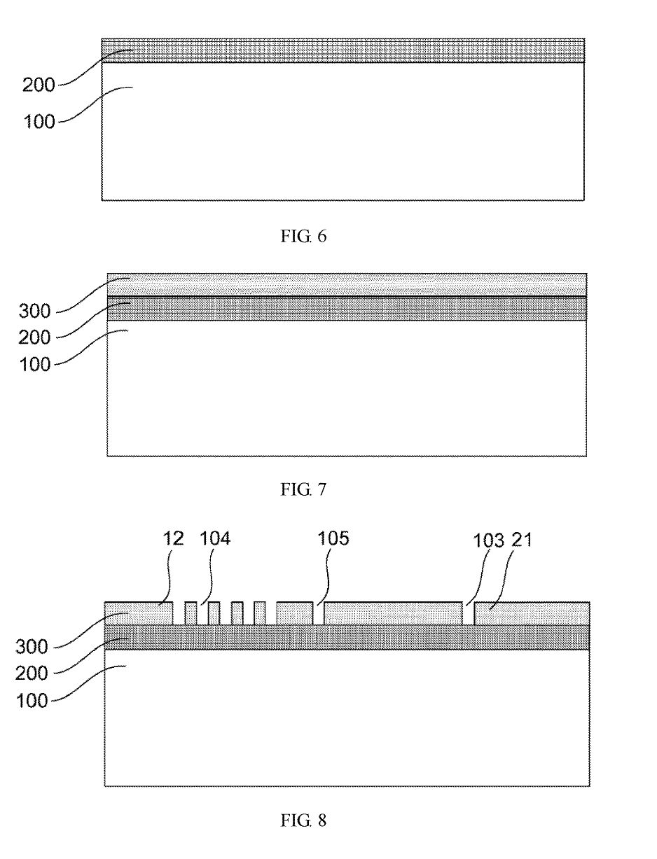

2) Referring to FIG. 6, a first isolating layer 200 is grown on the substrate 100, and the first isolating layer 200 for example selects silicon oxide.

3) Referring to FIG. 7, a first pole plate material layer 300 is grown on the first isolating layer 200, and the first pole plate material layer 300 for example selects polycrystalline silicon.

4) Referring to FIG. 8, the first pole plate material layer 300 is patterned and etched to form a back pole plate 12 of a first capacitor C1, a movable pole plate 21 of a second capacitor C2, and a first isolating groove 105 for isolating the back pole plate 12 of the first capacitor C1 from the movable pole plate 21 of the second capacitor C2, From FIG. 8, it can be seen that a plurality of through holes 104 are formed in the back pole plate 12 of the first capacitor C1, and a through hole 103 is formed in the central position of the movable pole plate 21 of the second. capacitor C2.

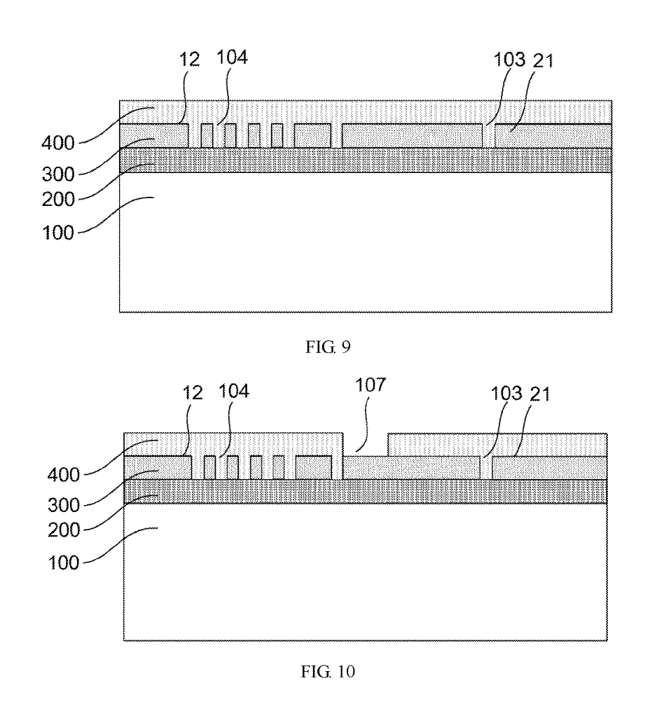

5) Referring to FIG. 9, a second isolating layer 400 is deposited on the first pole plate material layer 300, and the second isolating layer 400 for example selects oxide.

6) Referring to FIG. 10, a connecting window 107 is formed in the second isolating layer 400 above the movable pole plate 21 of the second capacitor C2, for connecting a movable pole plate 11 of the first capacitor C1 with a movable pole plate 21 of the second capacitor C2.

7) Referring to FIG. 11, a second pole plate material layer 500 is directly grown on the second isolating layer 400, and the second pole plate material layer 500 for example selects the polycrystalline silicon.

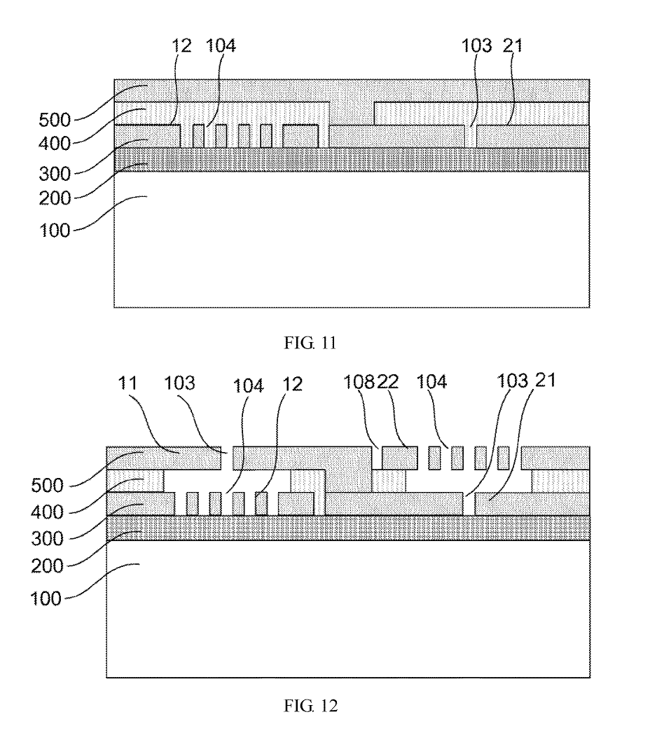

8) Referring to FIG. 12, the second pole plate material layer 500 is patterned and etched to form a movable pole plate 11 of the first capacitor C1, a back pole plate 22 of the second capacitor C2, and an isolating groove 108 for isolating the movable pole plate 11 of the first capacitor C1 from the back pole plate 22 of the second capacitor C2. From FIG. 12, it can be seen that at the connecting window 107, the movable pole plate 11 of the first capacitor C1, that is, the first vibrating diaphragm 11, and the movable pole plate 21 of the second capacitor, that is, the second vibrating diaphragm 21 can be connected together.

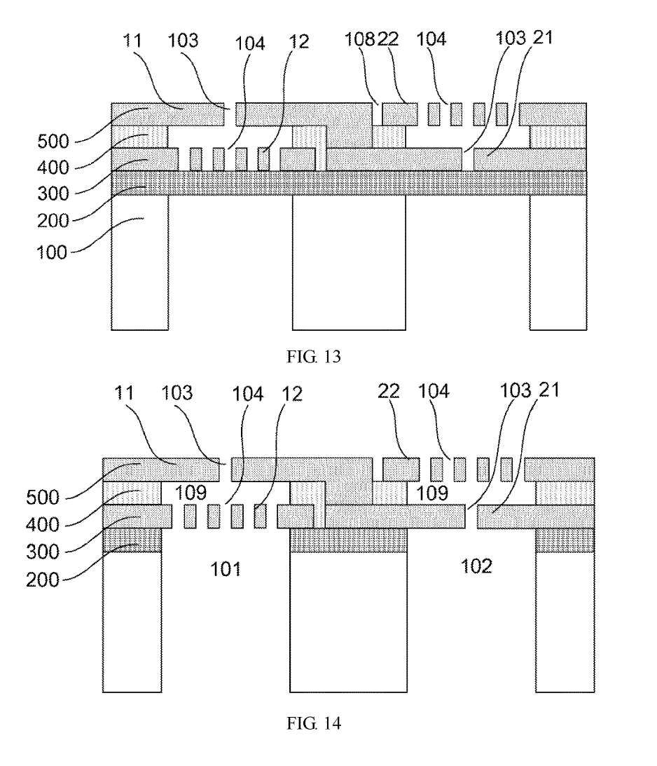

9) Referring to FIG. 13, the substrate 100 is etched from the lower part by a deep reactive ion etching (DRIP process to form back cavities of a first MEMS structure and a second MEMS structure.

10) The structure is released by a two-step release process, thereby finishing the machining of the whole device. Referring to FIG. 14, the first isolating layer 200 and the second isolating layer 400 of the first MEMS structure as well as the first isolating layer 200 of the second MEMS structure are etched from the bottom. After this step, a first opening 101 which run through from top to bottom, is formed below the first capacitor C1, a second opening 102 which run through from top to bottom, is formed below the second capacitor C2, and a clearance 109 is formed between the back pole plate 12 and vibrating diaphragm 11 of the first capacitor C1. Then the second isolating layer 400 of the second MEMS structure is etched from the top to form another clearance 109 between the back pole plate 22 and vibrating diaphragm 21 of the second capacitor C2.

It needs to be noted that the process flow is merely an exemplary flow, and if required, thicknesses of the back pole plates of the first capacitor C1 and the second capacitor C2 can be made larger than those of the vibrating diaphragms of the first capacitor C1 and the second capacitor C2

According to the differential-capacitance type MEMS microphone of the present invention, a pair of differential capacitors is designed side by side, differential detection is realized by two layers of films, and the present invention has the following beneficial effects.

1. The differential-capacitance type MEMS microphone is realized, and is favorable for filtering outside electromagnetic and noise interferences, improving a signal-noise ratio and a reception quality of output signals.

2. Since the clearances between the back pole plates and the movable pole plates of the differential capacitors are finished in one step, intervals of the differential capacitors can be made totally consistent, improving differential effect.

3. The process flow of manufacturing is simple and easy to control. The process flow is totally compatible with the current process for a single-capacitance type MEMS microphone, and the process needs no change.

Although some specific embodiments of the present invention have been demonstrated in detail with examples, it should be understood by a person skilled in the art that the above examples are only intended to be illustrative but not to limit the scope of the present invention.

1. A MEMS microphone element, the element comprising:
a base provided with a first opening and a second opening which run through from top to bottom; and
a first capacitor and a second capacitor disposed on the base in parallel, the first capacitor being disposed on the first opening, and the second capacitor being disposed on the second opening,
wherein the first capacitor comprises a first back pole plate located below, and a first vibrating diaphragm located above and opposite to the first back pole plate, the second capacitor comprises a second back pole plate located above, and a second vibrating diaphragm located below and opposite to the second back pole plate; and
the first capacitor and the second capacitor form a differential capacitor together.

2. The MEMS microphone element according to claim 1, wherein the first vibrating diaphragm and the second back pole plate are made of the same material, and the first back pole plate and the second vibrating diaphragm are made of the same material.

3. The MEMS microphone element according to claim 1, wherein the first vibrating diaphragm and the second vibrating diaphragm are electrically connected together to serve as a shared movable pole plate of the differential capacitor.

4. The MEMS microphone element according to claim 1, wherein sensing parts of the first back pole plate and the second back pole plate are provided with a plurality of through holes respectively, and the first vibrating diaphragm and the second vibrating diaphragm are provided with a through hole at their central positions respectively.

5. The MEMS microphone element according to claim 1, wherein the first back pole plate, the first vibrating diaphragm, the second back pole plate and the second vibrating diaphragm are made of any one of the following materials: polycrystalline silicon, silicon nitride attached with a polycrystalline silicon layer, and silicon nitride attached with a metal layer.

6. The MEMS microphone element according to claim 1, wherein the MEMS microphone element is suitable for two kinds of product structures in which a sound signal enters into the MEMS microphone element from above or below.

7. A method for manufacturing a MEMS microphone element, the method comprising the following steps:
S1, providing a substrate;
S2, growing a first isolating layer on the substrate;
S3, growing a first pole plate material layer on the first isolating layer; patterning and etching the first pole plate material layer to form a back pole plate of a first capacitor, a movable pole plate of a second capacitor and a first isolating groove for isolating the back pole plate of the first capacitor from the movable pole plate of the second capacitor;
S4, depositing a second isolating layer on the first pole plate material layer; forming a connecting window on the second isolating layer above the movable pole plate of the second capacitor, for connecting a movable pole plate of the first capacitor with the movable pole plate of the second capacitor;
S5, growing a second pole plate material layer on the second isolating layer, patterning and etching the second pole plate material layer to form the movable pole plate of the first capacitor, a back pole plate of the second capacitor and an isolating groove for isolating the movable pole plate of the first capacitor from the back pole plate of the second capacitor; and
S6, etching the substrate and the first isolating layer to form a first opening below the first capacitor and to form a second opening below the second capacitor, in which the first opening and the second opening run through from top to bottom; and etching the second isolating layer to form a clearance between the back pole plate and movable pole plate of the first and the second capacitor, respectively.

8. The method according to claim 7, wherein in the step S3, a plurality of through holes are formed in the back pole plate of the first capacitor and a through hole is formed in the central position of the movable pole plate of the second capacitor; and in the step S5, a plurality of through holes are formed in the back pole plate of the second capacitor and a through hole is formed in the central position of the movable pole plate of the first capacitor.

9. The method according to claim 7, wherein a thickness of the back pole plate of the first capacitor is larger than that of the movable pole plate, and a thickness of the back pole plate of the second capacitor is larger than that of the movable pole plate.

10. The method according to claim 7, wherein the MEMS microphone element is suitable for two kinds of product structures in which a sound signal enters into the MEMS microphone element from above or below.
